(19) United States
(12) Patent Application Publication
(10) Pub. No.: US 2025/0340164 A1
(43) Pub. Date: Nov. 6, 2025

(54) MOBILE SPA

(71) Applicants: Thomas J. Mikovits, Las Vegas, NV (US); Sara A. Mikovits, Las Vegas, NV (US); Deirdre A. Strunk, Las Vegas, NV (US)

(72) Inventors: Thomas J. Mikovits, Las Vegas, NV (US); Sara A. Mikovits, Las Vegas, NV (US); Deirdre A. Strunk, Las Vegas, NV (US)

(21) Appl. No.: 19/196,093

(22) Filed: May 1, 2025

Related U.S. Application Data
(60) Provisional application No. 63/642,993, filed on May 6, 2024.

(51) Int. Cl. B60P 3/36

(52) U.S. Cl. CPC B60P 3/36

(57) ABSTRACT

A mobile spa comprises a movable spa platform which defines an interior space, and spa equipment and/or stations located in the interior space, such as in dedicated areas in the interior space, for use in providing spa services. The mobile spa allows spa services to be rendered at different locations.

### RELATED APPLICATION DATA

This application claims priority to U.S. Provisional Application Ser. No. 63/642,993, filed May 6, 2024, which application is incorporated herein by reference in its entirety.

### FIELD OF THE INVENTION

The present invention relates to mobile wellness spas, and in particular to mobile spas configured to be driven or pulled on a road.

### BACKGROUND OF THE INVENTION

Spas have been around for thousands of years. Early spas includes areas of natural hot springs and the like. Newer spas include equipment and professionals which are configured to provide therapeutic, cosmetic and other wellness and relaxation services to people. For example, spas often include massage chairs or tables for people to sit or lay on while masseurs massage them. Spas also include other equipment and stations, such as salt rooms, steam rooms, saunas and the like which all are used to allow people to experience therapeutic and relaxation benefits. Today's spas are commonly found at resorts, hotels or other physical locations. Customers who desire spa services must thus locate a spa and then travel from their location, such as work or home, to the spa. The travel time and expense associated with the spa experience make many people forgo the experience all together.

It is with respect to these and other considerations that the instant disclosure is concerned.

### SUMMARY OF THE INVENTION

Aspects of the invention comprise a mobile spa which includes a body defining an interior, a plurality of wheels coupled to the body, and various spa equipment or stations located at an interior of the body. The interior may, in one example, include a number of rooms that are separated from each other, with different wellness stations located in each of the rooms. The mobile wellness spa may be a motor coach, a shuttle van, or a trailer configured to be pulled by a vehicle.

Further objects, features, and advantages of the present invention over the prior art will become apparent from the detailed description of the drawings which follows, when considered with the attached figures.

### DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIGS. 1-5 illustrate various embodiments of the disclosed concept.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

As employed herein, the term “coupled” shall mean connected together either directly or via one or more intermediate parts or components.

As employed herein, the term “numbered” shall mean one or an integer greater than one (i.e., a plurality).

Aspects of the invention comprise a mobile spa and methods of providing mobile spa services. In various exemplary embodiments, the technology described herein provides a self-contained mobile apparatus, such as a portable motor coach, shuttle van, or trailer. The self-contained mobile apparatus is configured to hold and transport spa equipment or features and to provide spa services to patrons via spa related equipment and stations. The self-contained mobile apparatus disclosed herein are configured for easy transportability and fast and easy set-up.

By way of example, the self-contained mobile apparatus described herein may be useful in remote locations in order to obviate the need for patrons to travel to and from a spa, such as county or state fairgrounds, craft shows, festivals, offices, residences, parks, athletic events, parking lots, and the like. The self-contained mobile apparatus herein also has utility in urban areas, such as where the ability to provide spa services to a person at their home or business saves them substantial time including travel time.

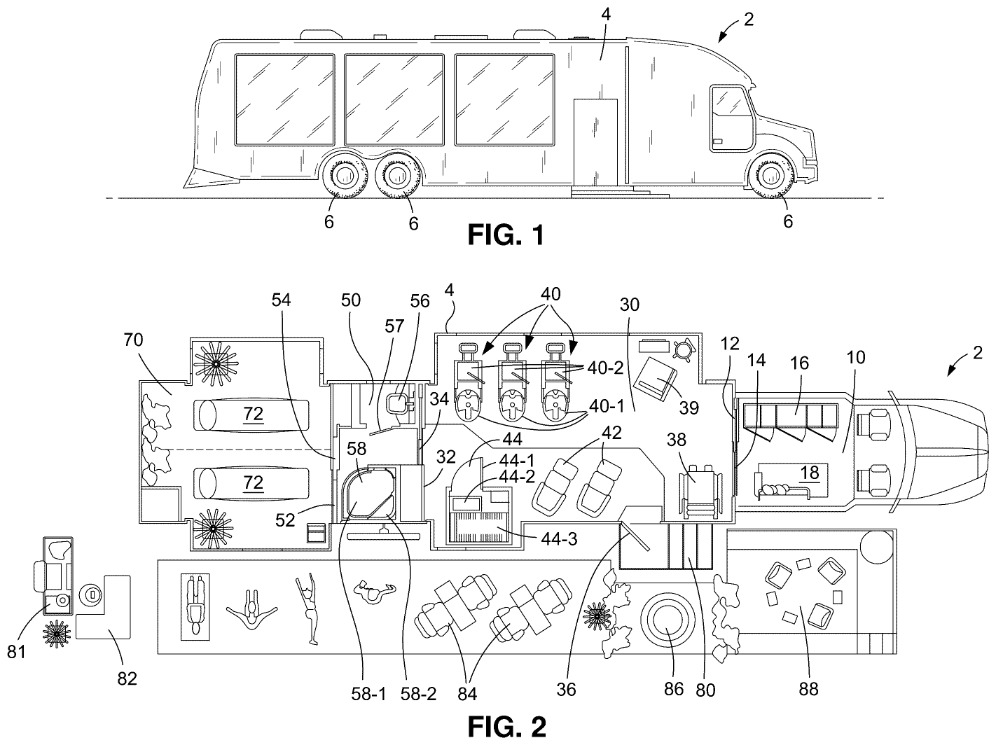

FIGS. 1 and 2 illustrate two views of a mobile spa in the form of a motor coach 2. As will be discussed below, the motor coach 2 is configured to actively transport spa equipment/features and personnel to the location of one or more people so that spa services can be provided thereto without the need for the people to travel to a spa. Masseurs and other professionals may travel with the motor coach 2 to provide or assist people with various spa treatments. For example, the motor coach 2 can generally be stated as including a body 4 and a plurality of wheels 6 coupled to movably support the body 4 (e.g., via axles), such as on a road. Additionally, although not shown, the motor coach 2 preferably also includes apparatus for creating drive, such as an engine (e.g., gas-powered, electric-powered, or hybrid thereof) and a transmission system for transferring power from the engine to axels, which may be coupled to the wheels 6. In other words, the motor coach 2 is configured to be driven on roads, including highways and residential roads.

FIG. 2 shows a simplified plan view of an interior of the motor coach 2. As shown, the body 4 of the motor coach 2 has a plurality of rooms 10,30,50,70. The rooms 10,30,50,70 may each define enclosed spaces that may be separated from each other. Additionally, although the motor coach 2 is shown with the four rooms 10,30,50,70, more or less than four rooms may be employed with a suitable alternative motor coach. Furthermore, the rooms 10,30,50,70 of the motor coach 2 are preferably separated from each other by physical structures, such as walls 12,32,52. In one example, the walls 12,32,52 each have a door 14,34,54 configured to be opened and closed in order to allow people to move between the rooms 10,30,50,70. As such, the motor coach 2 may function in substantially the same manner as a retail spa, with the added benefit that the motor coach 2 travels to people instead of requiring people to travel to and from a retail spa location. The walls 12,32,52 may be permanent, or might be movable (such as sliding, accordion, etc.)

Continuing to refer to FIG. 2, the motor coach 2 also has a plurality of different spa apparatus located in one or more of the rooms 10,30,50,70. In the first room 10, the motor coach 2 may have a number of lockers 16 and a salt therapy station 18, each of which may be coupled, optionally fixedly coupled, to a wall and/or floor of the first room 10. The lockers 16 may each define an interior space, have doors configured to be opened and closed to provide access to the interior space, and also have locks coupled to the doors. In one example, when the motor coach 2 has traveled to meet a group of people at their houses, offices, or other locations, the people may enter the motor coach 2 through a door 36 of the second room 30, walk through the door 14 and enter the first room 10, where they can store personal items (e.g., jackets, purses, etc.) in the lockers 16. The salt therapy station 18 may include a container with sodium chloride (salt) located in the container, with the sodium chloride being dispersible into surrounding air.

As shown in FIG. 2, the second room 30 may contain a medical station 38. This station 38 might comprise a chair or other support and associated equipment, such as for administering treatments such as an IV, cosmetic enhancers or the like. The second room 30 may also include at least one hair/make-up station, such as in the form of a styling chair 39 at which hair styling and/or make-up services may be performed. The second room 30 may also include a number of manicure/pedicure stations 40. The second room 30, or a portion thereof, may also include one or more red light therapy stations 42. In addition, the second room 30, or a portion thereof, may house a sauna 44.

, each of which may be coupled, optionally fixedly coupled, to a floor of the second room 30. The hair styling chair 39 may be rotatably coupled to the floor of the second room 30, such that the chair 39 rotates about a mounting pole which is oriented perpendicular to the floor of the second room 30. The manicure pedicure stations 40 may each include a sitting portion 40-1 and a leg rest portion 40-2 that is slidably coupled to the sitting portion 40-1 in order to allow a worker to give clients a pedicure in an adjustable manner. The recliner chairs 42 provide an option for clients on the motor coach 2 to relax, such as after they have had their hair styled or after they have received a manicure or pedicure.

Additionally, as shown in FIG. 2, the sauna 44 may define an interior area and include a door 44-1 configured to pivot or otherwise move between open and closed positions. The sauna 44 may be of various types, such as an infrared sauna which includes one or more infrared lamps. In that or other instances, the sauna 44 may employ dry heat and be kept at between 160-220 degrees Fahrenheit. Alternatively, the sauna 44 might be of other types, such as including other types of heat sources, including to create water vapor. For example, the sauna 44 might alternatively include a heat source 44-2 such as stones positioned above an electric heating source, and located in an interior of the sauna 44. The interior of the sauna 44 may include one or more a benches, and the benches and walls 44-3 may optionally be made of wood.

As shown in FIG. 2, each of the apparatus of the second room 30 may be stand-alone pieces of equipment or stations which are spaced from each other with enough room for clients to walk therebetween. In one example, each of the different stations of the second room are spaced at least one foot from each other in order to allow people to walk therebetween.

Continuing to refer to FIG. 2, the third and fourth rooms 50,70 each also include other apparatus for therapeutic treatment or relaxation, and are separated by the wall 52 and the door 54. As shown, the third room 50 includes a lavator 56 and a steam room 58, each of which may be coupled, optionally fixedly coupled, to a floor of the third room 50. The lavatory 56 may be sealed or divided from the rest of the third room 50 by a door 57, which is configured to pivot or otherwise move between open and closed positions. The steam room 58 may comprise an enclosed space that is configured to be heated by a steam generator, which may be provided with or separately coupled to the steam room 58. The steam generator may be configured to cause the interior of the steam room 58 to operate at between 105-135 degrees Fahrenheit, such as by heating water from an associated water storage vessel, which may be supported by a platform. The steam room 58 may also include a floor 58-1 for people to walk around in, and a sitting area or bench 58-2 extending upwardly and outwardly from the floor 58-1, each of which are located in the interior and configured to be sealed by a door.

Additionally, the door 54 readily opens and closes in order to allow people, who may be clients aboard the motor coach 2, to walk into the fourth room 70. In one example, the fourth room 70 may be a deep relaxation room including a number of massage and facial tables 72 each having a number of legs extending upwardly from and being coupled to a floor of the fourth room 70, and a horizontal table portion oriented generally perpendicular to the legs. The tables 72 may be spaced from each other enough for people (e.g., masseurs and associated clients) to walk therebetween. In one example, the two tables 72 are spaced over two feet from each other.

It will thus be appreciated that the motor coach 2 provides a self-contained spa in which one or more people can receive spa services of various types, including via different apparatus and stations. In a particular embodiment, various rooms or other designated areas are provided and may be sealed from each other so to reduce the transmission of sound from one area to another. This may be accomplished by the use of sound absorbing panels in the different rooms or areas.

In one example, the first, third, and fourth rooms 10,50,70 are all configured to be quieter than the second room 30, due to its relative distance from the door 36. Moreover, the fourth room 70 may be the quietest room, due to the fact that is spaced the greatest distance from the outside door 36 of the motor coach 2.

In some embodiments, the walls or other partitions may be movable, such as to change the configuration of the interior of the mobile spa into different configurations. For example, movable partitions might be opened in order to create larger spaces from two or more smaller spaces, such as dependent upon the desired use.

Additionally, because the motor coach 2 is a mobile spa, people in neighborhoods, offices, and the like do not have to travel in order to enjoy the full spa experience. Rather, the experience is brought to them.

Moreover, as shown in FIG. 2, extending from an exterior of the motor coach 2 are steps or stairs 80, such as to allow people to go into and out of the motor coach 2, e.g., via the door 36. The stairs 80 may be removably coupled to the motor coach 2, or may be integrally provided with the motor coach 2. In one embodiment, the mobile spa may include additional features or elements, such as which may be transported thereby but used at the exterior thereof.

For example, once the motor coach 2 has been moved to a designated location, a number of features or elements may be removed from the motor coach 2 and be placed near the motor coach 2. For example, as illustrated, such elements might comprise a number of additional relaxation stations, including a catering station (e.g., grill 81 and table 82), a number of relaxation chairs 84, a cold bathtub 86, and a recovery garden 88 including a number of foot stools and chairs, plants, etc.

Each of these spa elements may be storable in a compartment or other area of the motor coach 2, such that when the motor coach 2 arrives at a given location, people can enjoy relaxation in a calm and quiet environment in the interior of the motor coach 2 (e.g., in any of the rooms 10,30,50,70), and people can also enjoy relaxation outside at any of the aforementioned exterior stations which can quickly and easily be set up. It will also be appreciated that suitable alternative arrangements for the equipment and the stations in the various rooms 10,30,50,70 are contemplated—e.g., the massage tables 72 could be located in one of the rooms 10,30,50 instead of the room 70.

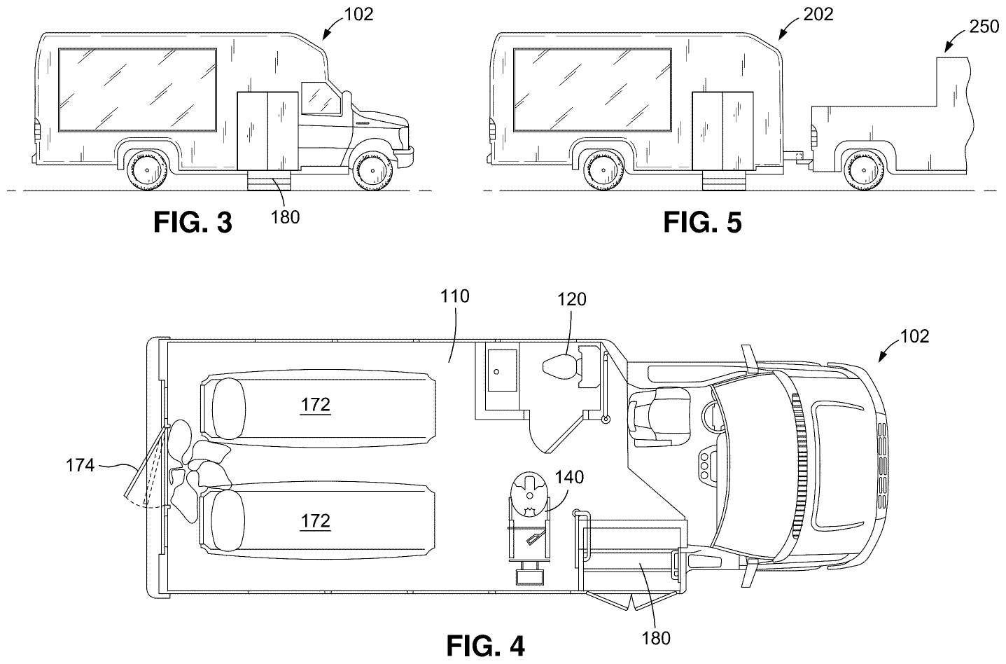

In addition to providing a mobile spa in connection with the motor coach 2 (FIGS. 1 and 2), the disclosed concept is also applicable to other mobile vehicles, each of which may traverse highways and residential roads. For example, FIGS. 3 and 4 show another mobile spa (e.g., shuttle van 102). The shuttle van 102 is similar to the motor coach 2 in function and purpose, and like numbers represent like features. As shown in FIG. 4, the shuttle van 102 includes a stairs apparatus 180 in order to allow people to move into and out of an interior room 110 of the shuttle van 102. Moreover, in the interior of the shuttle van 102 is a lavatory 120, a manicure and pedicure station 140, and a number of massage tables 172, each of which may be coupled, preferably fixedly coupled, to a floor of the room 110 of the shuttle van 102. Additionally, as shown, a door 174 may be coupled to a rear of the shuttle van 102, may pivot between open and closed positions.

It will be appreciated that shuttle van 102, like the motor coach 2, allows people to enjoy the relaxation experiences associated with a spa, without having to travel to and from the spa. Because the shuttle van 102 can travel to and from the locations where people already are, once the shuttle van 102 arrives, people can simply enter and leave the shuttle van 102. Additionally, although the disclosed concept has been described in association with the shuttle van 102 including the stations 120,140,172, it will be appreciated that suitable alternative stations are contemplated, including any of the stations in the rooms 10,30,50,70 of the motor coach 2, or any of the stations positioned at the exterior of the motor coach 2 in FIG. 2.

It can also be appreciated that the shuttle van 102 allows for a more concentrated spa experience, wherein people can have focused relaxation experiences. For example, it may be more cost effective for a business or residence to commission the shuttle van 102 than the motor coach 2. In such a situation, if an office only has two to three employees or a residence only has two people who desire massages or other treatments, it may be more economical for them to commission the shuttle van 102, rather than having the motor coach 2 come to the office.

In yet a further example of the disclosed concept, a trailer 202 is shown connected to a towing vehicle, such as a pickup truck 250, in FIG. 5. In this example, an interior of the trailer 202 may include any of the stations discussed in the interior or exterior of the motor coach 2 (FIG. 2). The trailer 202 thus provides yet a further example a mobile spa in which people at residences, offices, and the like can be provided with spa services without having to travel to and from a spa.

It will be appreciated from the above that the size of the mobile spa may vary, such as depending upon the desired application. The number and configuration of the spa features may vary, depending upon the size and shape of the mobile spa platform.

Most importantly, regardless of the size of the mobile spa platform, the mobile spa platform has one or more spa features associated therewith.

In various embodiments, the spa features may comprise equipment which is associated with an interior of a mobile spa platform. The equipment may be coupled to the mobile spa platform, such as to a floor, wall or the like. In one embodiments, the equipment may be movably mounted.

Aspects of the invention comprise a mobile spa which has an interior which is divided into different dedicated spaces, such as for different spa purposes. The number of spaces and their location may be selected, for example, to optimize each particular spa experience.

In one embodiment, the mobile spa includes associated equipment. For example, relative to a mobile spa which includes a steam room, the mobile spa preferably includes a water tank for storing water, a pump for delivering water through one or more water or steam lines to the spa, and one or more heating elements. In various embodiments, conventional spa equipment is modified for use in the mobile environment, such as to make it lighter and/or smaller for use in that environment.

In one embodiment, the mobile spa may include one or more additional features, such as windows, skylights, heating, cooling or other elements.

Other aspects of the invention comprise methods of providing mobile spa services. In one embodiment, the method comprises moving (such as driving or towing), a mobile spa from one location to a location where spa services are to be provided. In one embodiment, the method may include removing spa features from the mobile spa for use outside of the mobile spa. The method may also include the rendering of spa services to one or more people at the location using the elements of the mobile spa.

It will be understood that the above-described arrangements of apparatus and the method there from are merely illustrative of applications of the principles of this invention and many other embodiments and modifications may be made without departing from the spirit and scope of the invention as defined in the claims.

What is claimed is:

1. A mobile wellness spa, comprising:
a body defining an interior;
a plurality of wheels coupled to the body and configured to allow the body to be rolled on a road; and
a plurality of wellness stations coupled to an interior of the body.

2. The mobile wellness spa according to claim 1, further comprising an apparatus for powering the body such that the plurality of wheels can be rolled on a surface, wherein the mobile wellness spa is a motor coach.

3. The mobile wellness spa according to claim 1, further comprising an apparatus for powering the body such that the plurality of wheels can be rolled on a surface, wherein the mobile wellness spa is a shuttle van.

4. The mobile wellness spa according to claim 1, wherein the mobile wellness spa is a trailer configured to be pulled by a vehicle.
